(19) United States
(12) Patent Application Publication
(10) Pub. No.: US 2009/0266305 A1
(43) Pub. Date: Oct. 29, 2009

(54) Floating Illusions

(76) Inventor: Karl J. Pavlowski, Green Bay, WI (US)

Correspondence Address: STEVEN H GREENFIELD, 4649 SEMINOLE TRAIL, GREEN BAY, WI, 54313, US

(21) Appl. No.: 12/109,656

(22) Filed: Apr. 25, 2008

(51) Int. Cl. A01K 63/00; B23P 25/00

(52) U.S. Cl. 119/253; 29/527.1

(57) ABSTRACT

A decorative assembly comprising of a structure supporting an ornamental object such as a natural rock, an artificial rock, or an aquatic animal figurine is disclosed. The structure, comprising a base and a rod attached to the base, is transparent thereby giving the illusion of a floating object. The structure is placed in small bodies of water such as aquariums, wishing wells, and aquatic animal sanctuaries for ornamental purposes and to enhance the environment of the aquatic life.

### FIELD OF THE INVENTION

The present invention relates to decorative objects and artifacts, such as natural rocks, artificial rocks, and aquatic animal figurines, placed in small bodies of water, such as aquariums, wishing wells, and aquatic animal sanctuaries for ornamental purposes and to enhance the environment of aquatic life. An object or artifact is attached to a substantially transparent rod connected to a substantially transparent base placed on the floor of the water body thereby giving the illusion of the object or artifact floating at depths that may vary from near the floor of the water body to the surface of the water.

### BACKGROUND OF THE INVENTION

The natural habitat for aquatic animals such as fish, reptiles and amphibians in oceans, seas and lakes comprises of a variety of plants, rocks, sand, gravel and other organisms on which the fish feed. Reproducing a semblance of a natural habitat for fish in smaller bodies of water, such as aquariums, is challenging, since the water tends to be relatively shallow and there are fewer places for the fish to hide and reproduce. This causes the fish a considerable amount of stress. Artificial habitats for aquatic animals, such as fish and reptiles, and amphibians, such as turtles and frogs, therefore contain gravel, plants, rocks, driftwood and floating islands to make the aquatic animals' surroundings more natural and comfortable. Furthermore, some habitats include both large and small aquatic animals, as well as amphibians, thus placing the smaller ones at risk of being devoured by the larger animals. A well designed artificial habitat for aquatic animals and amphibians reduces this risk by providing accessories for the smaller animals to hide, rest and spawn.

A variety of artificial habitat accessories have been disclosed in the art. These accessories serve the dual purpose of enhancing aquatic and amphibian living environment and to provide ornamentation. These include floating islands, rocks of various sizes and shapes, plants, and gravel. U.S. Pat. Nos. 3,327,686, 6,532,899 and 5,722,347 relate to floating islands and platforms. U.S. Pat. Nos. 4,708,089 and 6,564,748 relate to habitat systems that provides living space for underwater animals. U.S. Pat. No. 4,820,556, U.S. Pat. No. 5,640,929, U.S. Pat. No. 6,083,576, and U.S. Pat. No. 6,309,714 disclose decorative ornaments for aquariums and terrariums. U.S. Pat. No. 6,672,250 is directed to a design serving a dual purpose of ornamentation and enhancing the environment of aquatic animal habitat.

### SUMMARY OF THE INVENTION

It is the object of the present invention to provide natural rocks or manmade artifacts in water bodies at depths varying from near the floor of the water bodies to the surface of the water in fish and amphibian simulated habitats in order to more closely simulate their natural environment. These simulated habitats include aquariums, and small ponds, lakes, and streams. The manmade artifacts may include, but not limited to artificial rocks, and ornamental figures and figurines made of ceramic, pottery, metal or plastic representing various artistic and decorative objects including fish and other aquatic animals.

It is also the object of the present invention to add decoration and ornamentation to small bodies of water such as aquariums, wishing wells, decorative fountains, and aquatic animal sanctuaries. It is further the object of the present invention to provide hiding, refuge and rest for the smaller fish, reptiles and amphibians from the larger predators that may be present in the body of water.

In the preferred embodiment of the present invention, a natural rock or manmade artifact assembly is constructed of a base made of a substantially transparent polymer, a rod also made of a substantially transparent polymer, and the natural rock or artifact of choice. However, assemblies having multiple rods and floating objects sharing one base also falls within the scope of the present invention. Having one large floating object supported by more than one base is likewise within the context of the present invention.

A support rod socket made as well of transparent polymer is attached to the base and serves as a medium for joining the rod to the base. The rod is fitted at one end into a hole drilled into the support rod socket and glued to achieve a permanent attachment. The rod is fitted at the other end into a hole drilled into the natural rock or artifact and glued to achieve a permanent attachment. The assembly, including the base, support rod socket, the rod and the natural rock or artifact, is placed into the water body having the base positioned on the floor of the water body and having the floating object supported by the rod placed at depths varying from near the bottom of the water body to the surface of the water. The transparency of the base, support rod socket, and rod create the illusion of a floating natural rock or artifact. In another embodiment of the present invention, a substantially transparent polymer having a slight color tint is used to construct the base, the rod and the support rod socket. The preferred color tint is one that blends in with the other objects in the immediate environment of the assembly, and should be light as not to interfere with the floating rock illusion. The preferred polymer of the present invention is an acrylic base polymer, but other transparent polymers including, but not limited to, polycarbonates, cyclic olefin polymers, styrenic polymers, polyesters, polyethersulfone, and polyimides containing an alicyclic structure, as well as glass are included within the framework of the present invention. It should be understood that the present invention embodiments for the base, rod and support rod socket are not limited to transparent polymers and include visible fluorescent polymers having varying degrees of shades and intensities of color.

The rod component of the natural rock or artifact assembly may have a straight, curved or random configuration. The preferred embodiment is an assembly having a straight rod design. However, a curved or random shaped rod may be utilized in a situation where a straight rod assembly does not fit well in an aquarium crowded with plants and a curved rod provides more flexibility for assembly placement.

### BRIEF DESCRIPTION OF THE DRAWINGS

FIG. 1 shows the straight rod rock assembly design with the defined outline of the base and rod (A), and a nearly invisible outline as it would appear in the water body (B).

FIG. 1a shows the curved rod rock assembly design with the defined outline of the base and rod (A), and a nearly invisible outline as it would appear in the water body (B).

FIG. 2 illustrates the straight rod design embodiment of FIG. 1 in an aquarium setting.

FIG. 2a illustrates the curved rod design embodiment of FIG. 2 in an aquarium.

FIG. 3 portrays an ornamental assembly comprised of a turtle figurine attached to a straight rod in an aquarium setting.

FIG. 4 depicts an ornamental assembly comprised of a fish figurine positioned on a straight rod.

FIG. 5 represents an ornamental assembly comprised of a crab figurine positioned on a curved rod.

FIG. 6 describes the dimensions of an assembly embodiment having two rocks attached to two straight rods sharing one hexagon shaped base. A side view of the assembly (A) and a top view of the assembly excepting the rocks (B) are presented.

FIG. 7 describes the dimensions of an assembly embodiment having a turtle figurine on one straight rod attached to one base. A side view of the assembly (A) and a top view of the assembly excepting the figurine (B) are presented.

### DETAILED DESCRIPTION OF THE INVENTION

The preferred shape for the base is rectangular having a length, a width and a thickness. However, a base having other geometric shapes such as circles, triangles, pentagons, hexagons, heptagons, and octagons as well as other random shapes also falls within the framework of the present invention. The base has a top side and a bottom side which is positioned on the floor of the body of water.

The preferred shape for the rod of the present invention is cylindrical and straight. A rectangular shaped rod represents another embodiment of the present invention. Likewise a curved rod also presents a workable design in the context of the present invention in situations where a straight rod is not the best fit for the body of water. The preferred placement of the natural rock or artifact is at or near the surface of the water; however placing the rock below the surface is also within the framework of the present invention.

The dimensions of the assembly are designed to be commensurate with the body of water into which the assembly is placed. It should therefore be understood that the length, width and height of the natural rock or artifact assembly may range from several inches to several feet. The thickness of the base may range between about 0.06″ to about 1″, with the preferred thickness ranging between about 0.177″ to 0.236″. The length and width of the base may range from about 4″ to about 36″, and the length and width of the ornamental objects may range from about 2″ to about 8 feet. The straight line length of the rod from one end to the other must be approximately equal to the depth of the body of water in order to support the natural rock or artifact at about the water surface level. The diameter of the acrylic rod ranges from about 0.25″ to about 3″, while the diameter of the support rod socket may range from about 0.75″ to about 4″, and the height of the support rod socket may range from about 0.5″ to about 5″.

The base for the assembly is cut to size using conventional saws equipped with special blades designed to cut composites. The corners may be cut to a 45 degree angle or rounded off for better appearance and safety. A support rod socket having a cylindrical shape, and having a top side and a bottom side is attached to the top side of the base. The diameter and height of the support rod socket vary depending on the application and the size of the base and the diameter of the rod. Generally, the diameter and the height of the support rod socket needs to exceed the diameter of the rod lower end by at least 0.25″. Prior to attaching the support rod socket to the base, a hole of a diameter slightly larger than that of the rod is drilled into top side of the support rod socket. The attachment of the support rod to the base is accomplished by applying methylene chloride to the bottom surface of the support rod socket, then pressing the support rod socket onto the center top side of the base. The methylene chloride chemically dissolves the acrylic material when applied onto a surface. When the support rod socket is pressed against the surface of the base top side, a strong bond is created after the dissolved acrylic material is allowed to resolidify. To attach the rod to the base, methylene chloride is applied to the hole drilled into the top side of the support rod socket. The rod lower end is then inserted and pressed into the hole. Likewise, a strong bond is created between the rod and the support rod socket after the dissolved acrylic material is allowed to resolidify. While the use of methylene chloride is the preferred embodiment for attaching the support rod socket onto the base and for attaching the rod to the support rod socket, other attaching means, such as the use of heat and adhesives, are also embodiments of the present invention.

The floating objects attached to the top of the rod may comprise of natural rocks made of common materials such as silicon, granite or limestone, or floating artifacts which may comprise of artificial rocks or figurines representing various aquatic animals made of fake wood, plastic, ceramic, metal or combinations thereof.

To attach the support rod to a natural rock or an artifact, a hole having a diameter slightly larger than that of the upper end of the support rod is drilled into it. To drill the holes into a hard natural rock, a drill press with a water coolant system and a carbide or diamond drill are used to drill a hole of varying depth. The depth of the hole is determined by the size and thickness of the rock. The hole is not drilled all the way through the rock so the support rod can be inserted into the rock and the rock rests atop the support rod. The rock is then thoroughly cleaned to remove any impurities, both natural and those resulting from the drilling. Once the rock has been cleaned and completely dried, a synthetic rubber coating is sprayed on the rock, or the rock can be dipped in a bath of the synthetic rubber coating if so desired. The synthetic rubbers that can be used for this purpose include, but are not limited to, silicone rubbers, nitrile elastomers, polychloroprene, urethane elastomers, butadiene rubbers, styrene, isoprene, and ethylene dichloride. The coating helps limit any possible leaching of minerals from the rock into the aquarium water so as not to affect the pH of the aquarium water. It also enhances the natural appearance of the rock by helping bring out the colors and texture. Some rocks may not require the synthetic rubber coating; thus in some embodiments of the present invention, this step may be left out.

After the rock has been properly prepared, it is attached to the support base unit using acrylic epoxy resin. The epoxy resin is a two-part mixture that is mixed according to the manufacturers specifications. Once the epoxy resin is properly mixed, a small amount is placed into the hole made in the rock and the support rod is placed into the hole. It is then left to dry. Once dried, the rock is permanently attached to the support rod. A similar procedure should be used for attaching the rod to an artifact made of a hard material such as ceramic or metal. For cleaner and softer materials such as wood, a drill press with a water coolant system and a carbide or diamond drill may not be required.

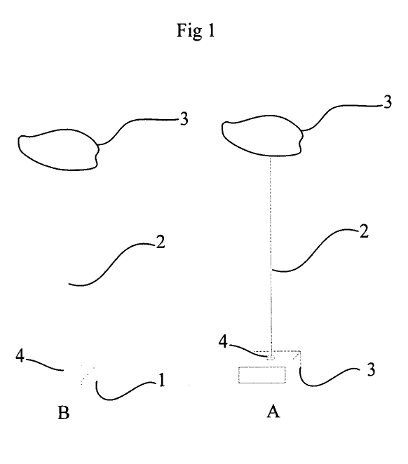

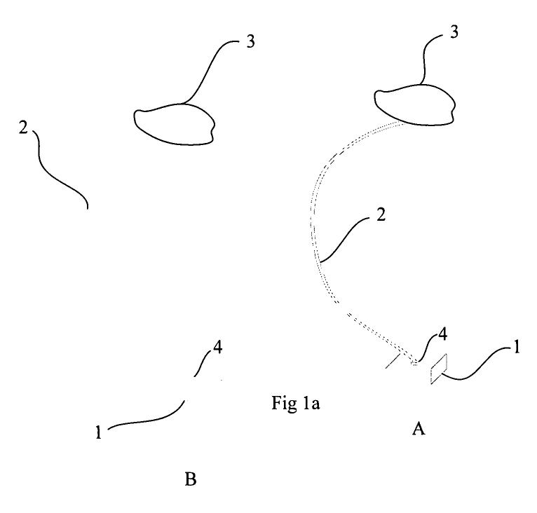

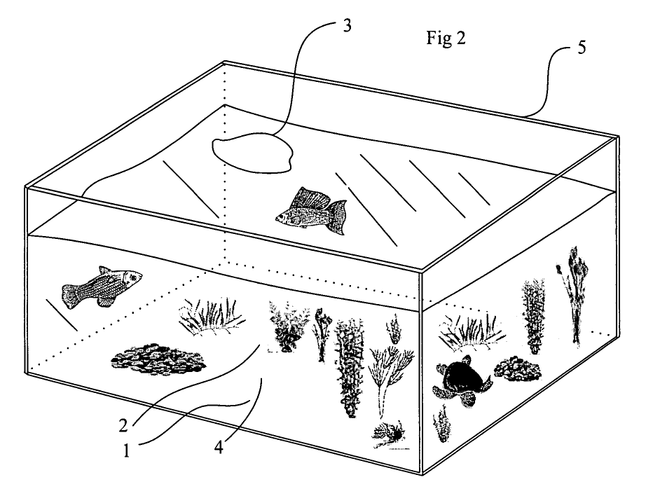

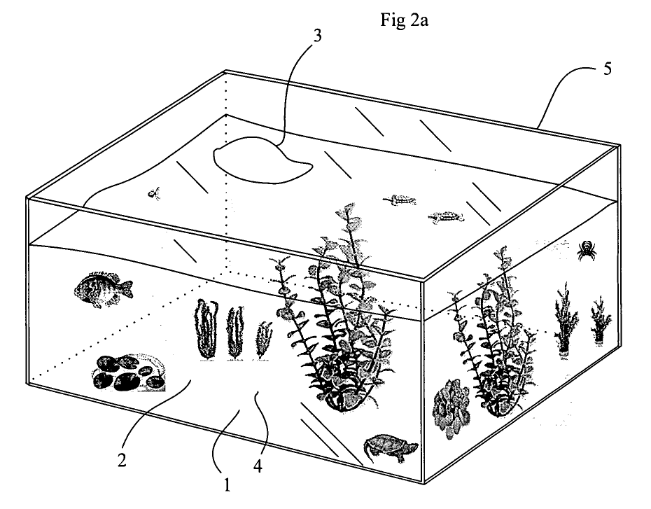

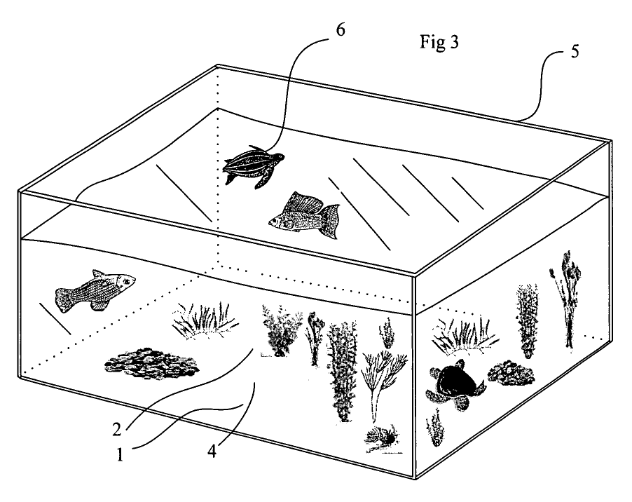

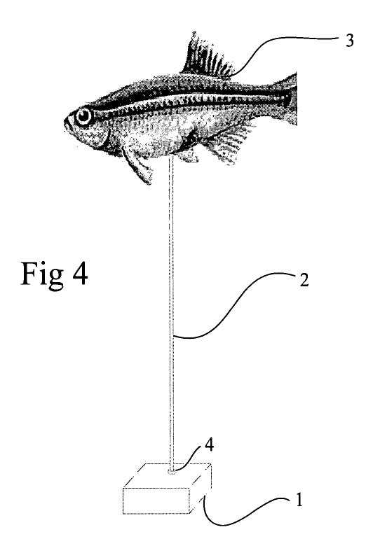

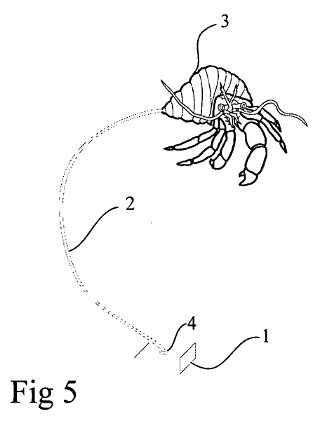

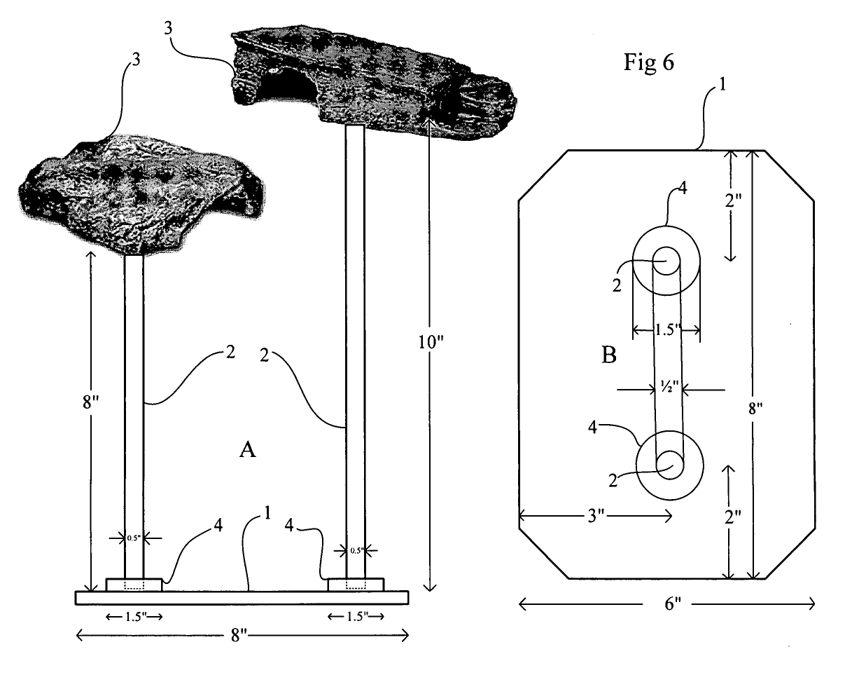

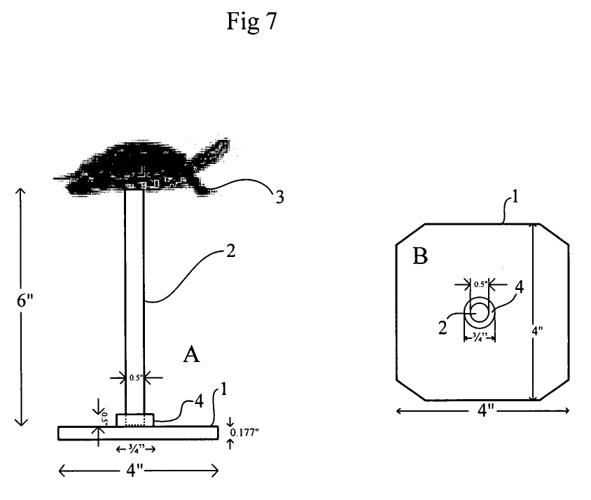

FIG. 1 is a representation of a rock assembly comprising of a rock (3) attached to a straight rod (2) that in turn is attached to the base (1) via a support rod socket (4). The assembly is shown with a clear outline (A) and a substantially transparent outline (B). When the assembly is immersed in the body of water, the acrylic material composition of the assembly structure gives it an appearance of only a faint silhouette barely visible through the water, while the rock is visible and appears to be floating on the surface of the water. FIG. 1a is a representation of a rock assembly comprising of a rock (3) attached to a curved rod (2) that in turn is attached to the base (1) via a support rod socket (4). The assembly is shown with a clear outline (A) and a substantially transparent outline (B). FIG. 2 illustrates the assembly of FIG. 1 in an aquarium (5) having plants, gravel, fish and a turtle. FIG. 2a illustrates the assembly of FIG. 1a in an aquarium (5) having plants, gravel and various aquatic animals. FIG. 3 features a turtle figurine (6) assembly in an aquarium (5) setting having a straight rod (2) that in turn is attached to the base (1) via a support rod socket (4). FIG. 4 depicts an assembly having a straight rod (2) that is in turn attached to the base (1) via a support rod socket (4) and a fish (3) figurine. FIG. 4 depicts an assembly having a straight rod (2) that in turn is attached to the base (1) via a support rod socket (4) and a fish (3) figurine. An assembly having a curved rod (2) attached to the base (1) via a support rod socket (4) and a crab figurine (3) is shown in FIG. 5. FIG. 6 and FIG. 7 show the dimensions of two assembly embodiments having straight rods indicating the bases (1), straight rods (2) attached to the bases (1) via support rod sockets (4). FIG. 6 is for one floating rock (3) and one immersed rock (3), while FIG. 7 is for a turtle figurine (3).

I claim:

1. An assembly for a closed body of water comprising:
a base having a top side and a bottom side;
a support rod socket having a top side and a bottom side, said bottom side of the support rod socket is permanently attached to the top side of the base;
a rod having an upper end and a lower end, said lower end of said rod is permanently attached to the top side of the support rod socket; and
an ornamental object having a top side, a bottom side, a left side and a right side, said object is permanently attached to the upper end of the rod.

2. The assembly of claim 1, in which the bottom side of the base is positioned onto the floor of the body of water and the ornamental object is positioned at the surface of the water.

3. The assembly of claim 1, wherein the base, the support rod socket, and the rod are made of substantially transparent material.

4. The ornamental assembly of claim 3, wherein the base, the support rod socket, and the rod are made of substantially transparent material having a color tint.

5. The ornamental assembly of claim 3, wherein the base, the support rod socket, and the rod are made of an acrylic base polymer.

6. The ornamental assembly of claim 1, wherein the rod is substantially straight, said upper end of said rod is attached to the bottom side of said object.

7. The ornamental assembly of claim 1, wherein the rod is substantially curved said upper end of said rod is attached to the ornamental object at one side of said ornamental object.

8. The ornamental assembly of claim 1, wherein the ornamental object is a natural rock.

9. The ornamental assembly of claim 1, wherein the ornamental object is an artificial rock.

10. The ornamental assembly of claim 1, wherein the ornamental object is an aquatic animal figurine.

11. A method for manufacturing the assembly of claim 1 comprising: providing an ornamental object; providing a rod of an appropriate length and material; providing a base made of the desired material and having the desired dimensions; providing a support rod socket made of the desired material and having the desired dimensions; drilling a hole into the top side of said support rod socket, said hole having a diameter substantially the same as the diameter of the rod lower end; attaching the bottom side of the support rod socket with the top side of the base; inserting the bottom end of the rod into the hole drilled on the top side of the support rod socket; permanently attaching the bottom side of said rod onto the top side of the support rod socket; drilling a hole into the side and through a substantial portion of the ornamental object thereby exposing drilled inner surfaces; cleaning the debris and impurities from the drilled inner surfaces of said ornamental object; applying an epoxy resin onto the drilled surfaces of said ornamental object; inserting the upper end of the rod into the hole; and allowing the epoxy resin to dry.

12. A method for manufacturing the assembly of claim 1 comprising: providing an ornamental object; providing a rod of an appropriate length and material; providing a base made of the desired material and having the desired dimensions; providing a support rod socket made of the desired material and having the desired dimensions; drilling a hole into the top side of said support rod socket, said hole having a diameter substantially the same as the diameter of the rod lower end; attaching the bottom side of the support rod socket with the top side of the base; inserting the bottom end of the rod into the hole drilled on the top side of the support rod socket; permanently attaching the bottom side of said rod onto the top side of the support rod socket; drilling a hole into the side and through a substantial portion of the ornamental object exposing drilled inner surfaces; cleaning the debris and impurities from the drilled inner surfaces of said ornamental object; applying a rubber coating to the drilled surfaces of said ornamental object; applying an epoxy resin onto the rubber coated surfaces of said ornamental object; inserting the upper end of the rod into the hole; and allowing the epoxy resin to dry.

13. The method of claim 12, wherein joining the bottom side of the support rod socket with the top side of the base is accomplished by applying methylene chloride to the bottom of the support rod socket; and pressing the bottom of the support rod socket onto the top of the base.

14. The method of claim 12, wherein joining the bottom end of the rod with the top side of the support rod socket is accomplished by applying methylene chloride into the drilled hole at the top the support rod socket; inserting the rod lower end into the drilled hole at the top the support rod socket; and pressing the rod lower end into said drilled hole.

15. The method of claim 12, wherein the rubber coating is selected from the group consisting of silicone rubbers, nitrile elastomers, polychloroprene, urethane elastomers, butadiene rubbers, styrene, isoprene, and ethylene dichloride.
